(19) United States
(12) Patent Application Publication
(10) Pub. No.: US 2005/0219371 A1
(43) Pub. Date: Oct. 6, 2005

(54) Camera device

(75) Inventor: Takaaki Iwama, Tokyo (JP)

Correspondence Address: MCGINN & GIBB, PLLC, 8321 OLD COURTHOUSE ROAD, SUITE 200, VIENNA, VA, 22182-3817, US

(73) Assignee: Clarion Co., Ltd., Tokyo (JP)

(21) Appl. No.: 11/084,028

(22) Filed: Mar. 21, 2005

(30) Foreign Application Priority Data
Mar. 31, 2004 (JP) P2004-102376

(51) Int. Cl. H04N 5/225

(52) U.S. Cl. 348/207.99

(57) ABSTRACT

A camera device including a camera case, a camera body that is supplied with power from an external power source and air-tightly accommodated in the camera case, a primary coil unit that is disposed at the outside of the camera case and connected to the external power source, and a second coil unit that is accommodated in the camera case and electromagnetically coupled to the primary coil unit to supply power from the external power source to the camera body.

### BACKGROUND OF THE INVENTION

1. Field of the Invention

The present invention relates to a camera device to which power is supplied from an external power source.

2. Description of the Related Art

There is known a camera device having a camera case and a camera body which is mounted in the camera case and supplied with power from an external power source (for example, see JP-UM-A-5-90464). According to this type of camera device, it is general that the camera body is connected to the external power source through a power cable, and an opening through which the power cable is introduced is formed in the camera case.

The camera device as described above is mounted outdoors (for example, on a vehicle), and thus it is exposed to wind and weather. Accordingly, airtightness is required to the camera device, and thus the camera device is subjected to a waterproof treatment by clogging the gap between the opening of the camera case and the power cable with packing or the like.

In the camera device, however, even when the gap is clogged with packing or the like, the gap is slightly opened and thus it is difficult to keep airtightness. Accordingly, when the camera device as described above is used outdoors, water components such as water droplet, moisture, etc. invade into the camera case, and the invasion of the water components into the camera case fogs a camera lens or makes the camera device break down.

### SUMMARY OF THE INVENTION

The present invention has been implemented in view of the foregoing situation, and has an object to overcome the above problem of the related art and provide a camera device that can suppress invasion of water components such as water droplet, moisture, etc. into a camera case.

In order to solve the above problem, according to the present invention, there is provided a camera device comprising: a camera case; a camera body that is supplied with power from an external power source and air-tightly accommodated in the camera case; a primary coil unit that is disposed at the outside of the camera case and connected to the external power source; and a second coil unit that is accommodated in the camera case and electromagnetically coupled to the primary coil unit to supply power from the external power source to the camera body.

In the above camera device, the camera case may have a fit-in portion in which the primary coil unit is fitted, and the secondary coil unit may be disposed so as to face the primary coil unit under the state that the primary coil unit is fitted in the camera case.

The above camera device may be further equipped with a coil case in which the primary coil unit is accommodated, and the coil case may be secured to the camera case in accordance with a draw-out direction of a cable drawn out from the side surface of the coil case to the outside so that the primary coil unit and the secondary coil unit are rotated while kept to face each other.

Furthermore, in the above camera device, a filling material may be filled in the camera case to absorb vibration of at least the secondary coil unit.

Still furthermore, the above camera device may be further equipped with a video signal transmitter for wirelessly transmitting a video signal to an external video signal receiver, and the video signal transmitter may be accommodated in the camera case.

In the above camera device, the video signal transmitter may output a video signal to the secondary coil unit, and the video signal receiver may receive a video signal through the primary coil unit.

Furthermore, in the above camera device, the external power source may be a DC power source, a switching circuit for transmitting power may be provided between the primary coil unit and the external power source, and the switching circuit may carry out a switching operation in synchronism with a horizontal synchronous signal of the video signal.

Still furthermore, in the above camera device, a controller for controlling the camera body on the basis of a control signal may be accommodated in the camera case, and the controller may receive a control signal output to the primary coil unit through the secondary coil unit.

Still furthermore, in the cameral device, optical communications may be carried out between the video signal transmitter and the video signal receiver.

According to the present invention, moisture can be prevented from invading into the camera case.

### BRIEF DESCRIPTION OF THE DRAWINGS

FIG. 1 is a diagram showing a vehicle on which a camera device of a first embodiment is mounted;

FIG. 2 is a cross-sectional view showing the camera device;

FIG. 3 is a block diagram showing the schematic electric construction of the camera device;

FIG. 4 is a cross-sectional view showing a camera device according to a second embodiment;

FIG. 5 is a cross-sectional view showing a camera device according to a third embodiment;

FIGS. 6A and 6B are plan views showing a coil case; and

FIG. 7 is a block diagram showing the schematic electrical construction of a camera device according to a fourth embodiment.

### DETAILED DESCRIPTION OF THE PREFERRED EMBODIMENTS

Preferred embodiments according to the present invention will be described hereunder with reference to the accompanying drawings.

### [1] First Embodiment

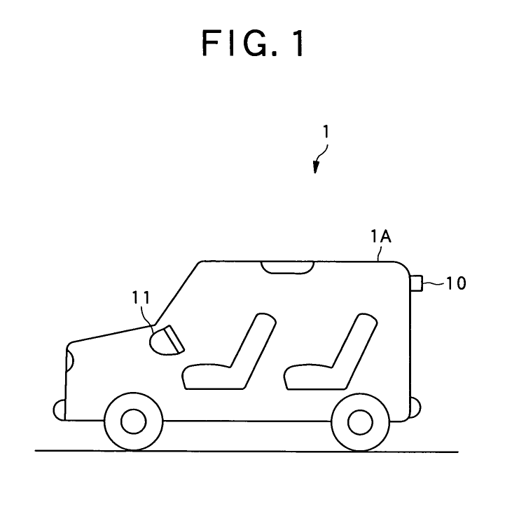

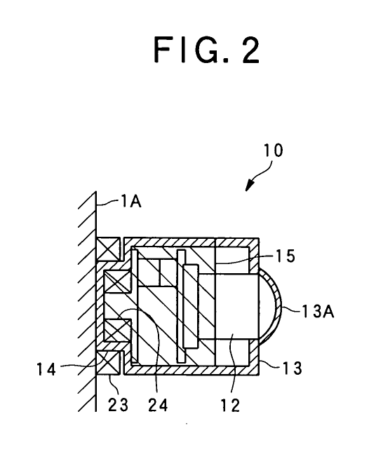

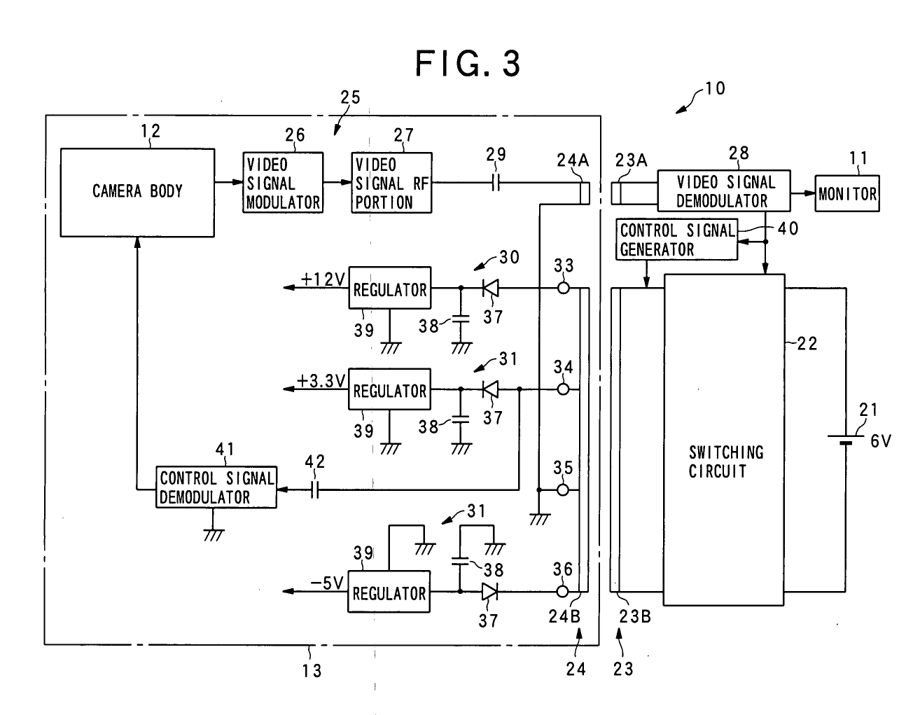

FIG. 1 is a diagram showing a vehicle on which a camera device 10 according to a first embodiment is mounted. FIG. 2 is a cross-sectional view showing the camera device 10, and FIG. 3 is a block diagram showing the schematic electrical construction of the camera device 10.

The camera device 10 is disposed outdoors, and it is a on-vehicle mount type camera device which is secured to the vehicle body of the vehicle 1. This camera device 10 is secured to the rear portion of the vehicle 1A and picks up images of the rear side of the vehicle 1. A monitor 11 equipped in the vehicle displays images on the basis of video signals achieved by camera device 10.

As shown in FIG. 2, the camera device 10 is equipped with a camera body 12 for picking up images of the surrounding of the vehicle 1 and outputting video signals representing the pickup images. The camera body 12 is equipped with a lens, CCD (Charge Coupled Device), etc. (not shown), and accommodated in a camera case 13 formed of resin.

An opening is formed in the front surface of the camera case 13 so as to face the image receiving portion of the camera body 12. The opening is covered by a transparent cover 13A to keep airtightness of the inside of the camera case 13. That is, the camera body 12 picks up images of the surrounds of the vehicle 1 through the cover 13A.

The camera body 12 is supplied with power by a vehicle side power source 21 (FIG. 3) serving as an external power source. In the first embodiment, the vehicle side power source 21 is a DC power source (for example, a DC power source of 6[V]), and a primary coil 23 is connected to the vehicle side power source 21 through a switching circuit 22. The primary coil 23 is disposed at the outside of the camera case 13 as shown in FIG. 2. The switching circuit 22 (FIG. 3) makes current flow intermittently into the primary coil 23 in order to transmit power to a secondary coil 24 side, and it comprises a switching element (not shown) and a driving circuit for driving the switching element. When the driving circuit of the switching circuit 22 drives the switching element, current flows in the primary coil 23. That is, the switching element is set to ON state while the driving signal is input from the driving circuit to the switching element, and current flows from the vehicle side power source 21 to the primary coil 23.

In the camera case 13 is accommodated a secondary coil 24 which is electromagnetically coupled to the primary coil 23 to supply power to the camera body 12 as shown in FIG. 2. That is, the power supply from the vehicle side power source 21 to the camera body 12 is carried out by the electromagnetic induction between the primary coil 23 and the secondary coil, so that it is not required to provide an opening for introducing a power cable into the camera case 13 and also it is not required to provide any power cable. accordingly, the airtightness in the camera case 13 can be kept, and invasion of water components such as water droplet, moisture, etc. can be prevented from invading into the camera case 13. Furthermore, since the airtightness in the camera case 13 can be kept, waterproof performance can be enhanced, and the camera body 12 can be prevented from being fogged by water droplet.

The specific construction will be described. The camera case 13 has a fit-in portion 14 in which the primary coil 23 is fitted. The primary coil 23 is secured to the vehicle body 1A, and the fit-in portion 14 is formed at the rear portion of the camera case 13. The camera case 13 is secured to the vehicle body 1A while the primary coil 23 is fitted in the fit-in portion 14. The secondary coil 24 accommodated in the camera case 13 is disposed so as to face the primary coil 23, and the primary coil 23 and the secondary coil 24 are arranged in proximity to each other. Accordingly, the leakage of magnetic flux between the primary coil 23 and the secondary coil 24 is reduced.

A hardenable filling material 15 which absorbs vibration of at least the second coil 24 is filled in the camera case 13. The filling material is insulative. The filling material 15 is filled so as to avoid the image receiving portion of the camera body 12 so that no trouble occurs in the image pickup of the camera body 12. Accordingly, even when the vehicle 1 vibrates during travel of the vehicle 1, the secondary coil 24 is prevented from jouncing in the camera case 13, and thus the secondary coil 24 can be prevented from being damaged. Furthermore, the airtightness can be more excellently kept by the filling material 15. Accordingly, waterproof test can be omitted.

In FIG. 3, a video signal transmitter 25 for carrying out the processing of transmitting video signals is connected to the camera body 12, and the video signal transmitter 25 is accommodated in the camera case 13.

The video signal transmitter 25 comprises a video signal modulator 26 for modulating a video signal output from the camera body 12, and a video signal RF portion 27 for converting the video signal thus modulated to a high-frequency signal (hereinafter referred to as RF signal) which can be output as electric waves.

A video signal demodulator (video signal receiver) 28 for receiving and demodulating the RF signal indicating the video signal is provided at the outside of the camera case 13.

The communication between the video signal transmitter 25 and the video signal demodulator 28 is carried out wirelessly. Specifically, the video signal transmitter 25 outputs an RF signal indicating a video signal to the secondary coil 25 through a coupling capacitor. The video signal demodulator 28 receives the RF signal indicating the video signal through the primary coil 23, converts the RF signal thus received to a video signal which can be processed in the monitor 11, and then outputs the video signal to the monitor 11. The monitor 11 displays pictures on the basis of the video signal thus input. That is, it is unnecessary to provide an antenna projecting from the camera case 13 separately in order to transmit the video signal, and the video signal can be transmitted wirelessly.

In the first embodiment, the primary coil 23 comprises a signal receiving coil portion 23A connected to the video signal demodulator 28 and a power supplying coil portion 23B connected to the switching circuit 22, and these elements are integrally formed with each other. Furthermore, the secondary coil 24 comprises a signal transmitting coil portion 24A connected to the video signal RF portion 27 through the coupling capacitor 29, and a power supplying coil portion 24B to which plural voltage stabilizing circuits 30, 31, 32 are connected, and these elements are integrally formed with one another.

Plural (for example, four) taps 33, 34, 35 and 36 are connected to the power supplying coil portion 24B of the secondary coil 24, and the voltage stabilizing circuits 30, 31, 32 are connected to the taps 33, 34 and 36, respectively. The tap 35 of these taps is connected to a ground line.

Different voltages occur at the respective taps 33, 34 and 36. Each of the voltage stabilizing circuits 30, 31, 32 has a diode 37, a capacitor 38 and a three-terminal regulator 39. Each voltage stabilizing circuit rectifies current input from the tap 33, 34, 36 through the diode 37, smoothens the rectified current and achieves a stable DC voltage at the three-terminal regulator 39. The stable DC voltage thus achieved is applied to each equipment in the camera case 13 containing the camera body 12 to thereby supply power to these parts.

That is, the voltage stabilizing circuits 30, 31, 32 apply different DC voltages to the corresponding equipment in the camera case 13, respectively. For example, the voltage stabilizing circuit 30 outputs a voltage of DC 12[V], the voltage stabilizing circuit 31 outputs a voltage of DC 3.3[V], and the voltage stabilizing circuit 32 outputs a voltage of DC-5[V]. By providing the plural taps 33, 34, 36 at different positions in the secondary coil 24 as described above, the different voltages can be achieved at the taps. Therefore, it is unnecessary to separately provide a switching circuit for adjusting the voltage by pulse-width modulation, and the circuit construction can be simplified.

The switching circuit 22 switches supply/non-supply of current to the power supplying coil portion 23B of the primary coil 23 in synchronism with horizontal synchronous signals of video signals.

Specifically describing, the video signal demodulator 28 detects the horizontal synchronous signal of the video signal, and outputs the horizontal synchronous signal or a signal synchronous with the horizontal synchronous signal (hereinafter the horizontal synchronous signal and the signal synchronous with the horizontal synchronous signal will be hereinafter referred to as “synchronous signal”) to the switching circuit 22.

The driving circuit (not shown) of the switching circuit 22 outputs the driving signal to the switching element on the basis of the input synchronous signal. That is, the driving circuit outputs the driving signal to the switching element only during the period when the synchronous signal is input thereto. The switching element is set to ON state only during the period when the driving signal is input.

Accordingly, the switching circuit 22 supplies current to the power supplying coil portion 23B of the primary coil 23 only during the period when the synchronous signal is input, and interrupts the current supply during the other period.

Noise is distributed from the power supplying coil portion 23B of the primary coil 23 to the signal receiving coil portion 23A through the switching operation of the switching circuit 22. However, in this case, it is rare that the noise is superposed on the portion other than the horizontal synchronous signal of the video signal (that is, the portion of the signal concerning pictures), and the noise caused by the switching operation of the switching circuit 22 can be prevented from disturbing pictures displayed on the monitor.

Furthermore, according to the first embodiment, a control signal generator 40 for generating and modulating a control signal for carrying out electric zooming, back light correction, etc. as camera functions is disposed in the vehicle 1. The control signal generator 40 outputs the control signal to the power supplying coil portion 23B of the primary coil 23. This control signal is output at a timing deviated from the synchronous signal.

A control signal demodulator (controller) 41 for receiving the control signal and controlling the camera body 12 on the basis of the control signal is accommodated in the camera case 13. The control signal demodulator 41 is connected to a tap of the secondary coil 24 through a coupling capacitor 42. The control signal output from the control signal generator 40 to the power supplying coil portion 23B of the primary coil 23 is received through the power supplying coil portion 24B of the secondary coil 24 by the control signal demodulator 41. The control signal demodulator 41 demodulates the received control signal and outputs it to the camera body 12. The camera body 12 carries out various kinds of processing such as zooming, etc. on the basis of the input control signal. Accordingly, it is not required to provide a control signal cable to be drawn out from the camera case 13 to the vehicle side, and the control of the camera body 12 can be wirelessly carried out by effectively using the primary coil 23 and the secondary coil 24.

According to the first embodiment, it is not required to provide the cables such as the power cable, the video signal cable and the control signal cable, etc. to be drawn out from the camera case 13 to the outside, and thus the airtightness of the camera case 13 can be enhanced. Accordingly, invasion of the water components into the camera case 13 can be suppressed, and when the camera body 12 is exchanged, all that is required to do is merely to exchange the camera case 13 itself with the camera body 12 contained in the camera case 13. Therefore, the maintenance performance can be enhanced.

Furthermore, since it is unnecessary to provide the cables such as the power cable, the video signal cable, the control signal cable, etc., the camera case 13 can be designed, not in a complicated structure, but in a simple structure, and thus the camera case 13 can be miniaturized. Furthermore, since no external connection terminal is needed, the camera device of this embodiment is hardly affected by electricity.

Still furthermore, power is supplied from the vehicle side power source 21 to the parts in the camera case 13 such as the camera body 12, etc. by the electromagnetic induction between the primary coil 23 and the secondary coil 24. Therefore, even when short-circuit occurs in some part (for example, the camera body 12) in the camera case 13, no over-current flows because there is leakage flux between the primary coil 23 and the secondary coil 24.

### [2] Second Embodiment

A second embodiment is different from the first embodiment in the positions of the primary and secondary coils. In the second embodiment, the same parts as the first embodiment are represented by the same reference numerals, and the description thereof is omitted.

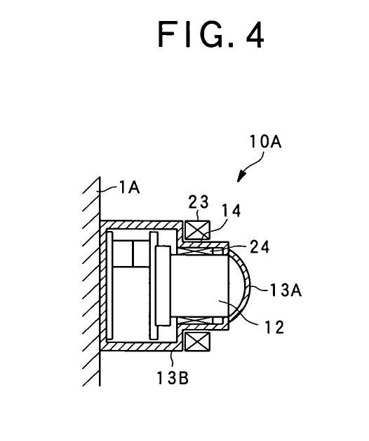

FIG. 4 is a cross-sectional view showing a camera device 10A according to a second embodiment.

The camera case 13B has a fit-in portion 14A in which the primary coil 23 is fitted. The fit-in portion 14A is formed at the front portion of the camera case 13B. The camera body 12 is disposed at the front portion in the camera case 13B. The secondary coil 24 accommodated in the camera case 13B is disposed so as to surround the peripheral surface of the camera body 12 so that the primary coil 23 and the secondary coil 24 faces each other and are proximate to each other.

The second embodiment has various effects of suppressing the invasion of the water components such as water droplet, moisture, etc. into the camera case as in the case of the first embodiment.

### [3] Third Embodiment

A third embodiment is different from the first and second embodiments in that the primary coil is accommodated in the coil case. In the following third embodiment, the same parts as the first embodiment are represented by the same reference numerals, and the description thereof is omitted.

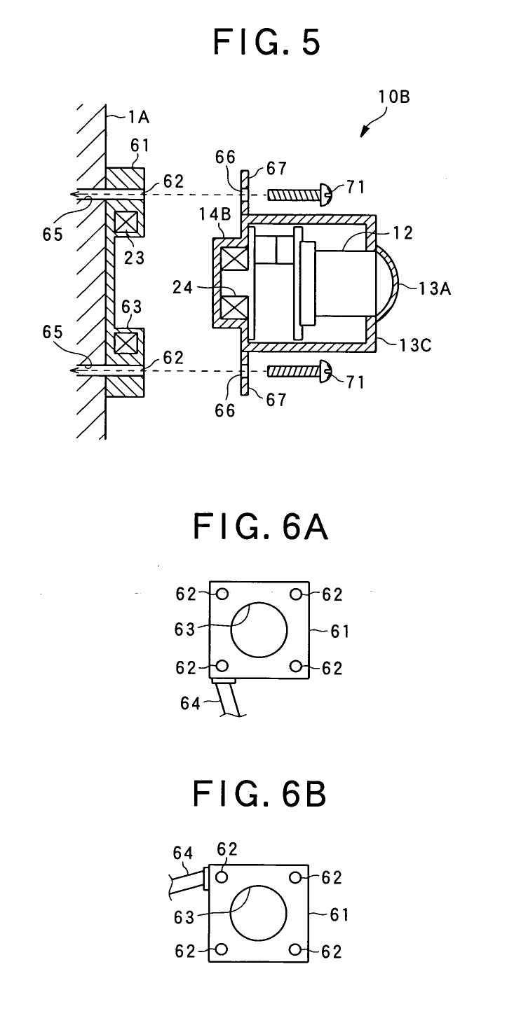

FIG. 5 is a cross-sectional view showing a camera device 10B according to a third embodiment. FIG. 6 is a plan view showing a coil case 61.

In the third embodiment, the primary coil 23 is accommodated in a coil case 61 formed of resin. The coil case 61 is secured to the camera case 13C, and also secured to the wall surface of the vehicle body 1A. That is, the coil case 61 is fixedly sandwiched between the camera case 13C and the vehicle body 1A.

Specifically describing, the coil case 61 has a face (back surface) confronting the vehicle 1A and a face (front surface) confronting the camera case 13C, and the back surface and the front surface are designed to have a regularly polygonal shape (square in the third embodiment). A screw hole 62 penetrating from the surface to the back surface of the coil case 61 is formed in the neighborhood of each corner of the square. Furthermore, a cylindrical recess portion 63 is formed on the surface of the coil case 61, and the primary coil 23 is annularly formed and arranged along the recess portion 63 in the coil case 61, and cables 64 such as a power cable, a video signal cable, etc. (see FIG. 6) are drawn out from the side surface of the coil case 61. Screw holes 65 are formed in the vehicle body 1A so as to confront the screw holes 62 of the coil case 61.

As in the case of the first embodiment, a fit-in portion 14B is formed at the rear portion of the camera case 13C. The fit-in portion 14B is formed in a cylindrical shape so as to project outwardly, and it is fitted in the recess portion 63 of the coil case 61 when the coil case 61 and the camera case 13C are fitted to each other.

When the coil case 61 and the camera case 13C are fitted to each other, the primary coil 23 and the secondary coil 24 are proximate to each other, and thus leakage of magnetic flux is reduced.

The camera case 13C is provided with a fixing plate 67 having screw holes 66 which are disposed so as to confront the respective screw holes 62 of the coil case 61 when the coil case 61 and the camera case 13C are fitted to each other. Accordingly, the coil case 61 and the camera case 13C can be fixed to the vehicle body 1A by screws 71.

The coil case 61 can be rotated while keeping the primary coil 23 and the secondary coil 24 to face each other before it is fixed by the screws 71. For example, even when the coil case 61 is rotated from the state of FIG. 6A to the state of FIG. 6B along the axis vertical to the vehicle body 1A by 90°, the screw holes 65 of the vehicle 1A face the screw holes 62 of the coil case 61, and thus it is possible to fix the camera case 13C and the coil case 61 to the vehicle body 1A by the screws 71. Accordingly, the coil case 61 can be properly rotated and fixed to the vehicle body 1A in accordance with a drawing direction of the cables 64 to be drawn out from the side surface of the coil case 61 to the outside so that the screw holes 62 of the coil case 61 face the screw holes 65 of the vehicle body 1A. Furthermore, the cylindrical fit-in portion 14B of the camera case 13C is fitted in the cylindrical recess portion 63 of the coil case 61. Therefore, the camera case 13C and the coil case 61 can be secured to the vehicle 1A by the screws 71 wile keeping the normal position of the camera case 13C without rotating the camera case 13c even when the coil case 61 is rotated.

### [4] Fourth Embodiment

A fourth embodiment is different from the first to third embodiments in that the video signal is transmitted through optical communications. In the fourth embodiment, the same parts as the first embodiment are represented by the same reference numerals, and the description thereof is omitted.

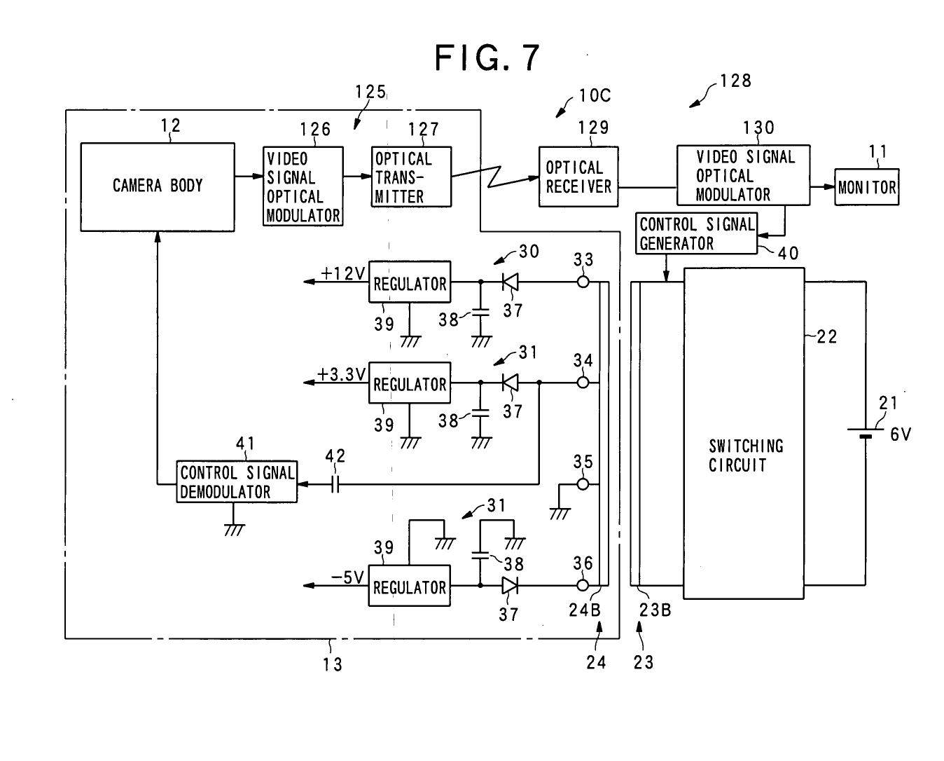

FIG. 7 is a block diagram showing the schematic electrical construction of a camera device 10C of the fourth embodiment.

In the fourth embodiment, the optical communication are carried out between the video signal transmitter 125 and the video signal receiver 128. The video signal transmitter 125 comprises a video signal optical modulator 126 for optically modulating a video signal output from the camera body 12 (converting the video signal to an optical signal), and an optical transmitter 127 for transmitting the optical signal thus modulated.

The video signal receiver 128 comprises an optical receiver 129 for receiving the optical signal transmitted from the optical transmitter 127, and a video signal optical demodulator 130 for demodulating (converting) the optical signal thus received to a vide signal (electrical signal). In the above construction, the optical signal is little affected by the switching circuit 22, and thus disturbance of pictures can be suppressed.

The present invention is not limited to the above embodiments, and various modifications may be made without departing from the subject matter of the present invention. For example, in the above embodiments, the camera device is secured to the rear portion of the vehicle, however, the present invention is not limited to this mode. For example, the camera device may be secured to any place of the vehicle. Furthermore, the setup position of the camera device is not limited to the vehicle body, and it may be secured to any other places other than the vehicle body.

1. A camera device comprising:
a camera case;
a camera body that is supplied with power from an external power source and air-tightly accommodated in the camera case;
a primary coil unit that is disposed at the outside of the camera case and connected to the external power source; and
a second coil unit that is accommodated in the camera case and electromagnetically coupled to the primary coil unit to supply power from the external power source to the camera body.

2. The camera device according to claim 1, wherein the camera case has a fit-in portion in which the primary coil unit is fitted, and the secondary coil unit is disposed so as to face the primary coil unit under the state that the primary coil unit is fitted in the camera case.

3. The camera device according to claim 1, further comprising a coil case in which the primary coil unit is accommodated, and the coil case is secured to the camera case in accordance with a draw-out direction of a cable drawn out from the side surface of the coil case to the outside so that the primary coil unit and the secondary coil unit are rotated while kept to face each other.

4. The camera device according to claim 1, wherein a filling material is filled in the camera case to absorb vibration of at least the secondary coil unit.

5. The camera device according to claim 1, further comprising a video signal transmitter for wirelessly transmitting a video signal to an external video signal receiver, wherein the video signal transmitter is accommodated in the camera case.

6. The camera device according to claim 5, wherein the video signal transmitter outputs a video signal to the secondary coil unit, and the video signal receiver receives a video signal through the primary coil unit.

7. The camera device according to claim 6, further comprising a switching circuit that transmits power and is disposed the between the primary coil unit and the external power source, wherein the external power source is a DC power source and the switching circuit carries out a switching operation in synchronism with a horizontal synchronous signal of the video signal.

8. The camera device according to claim 5, further comprising a controller that controls the camera body on the basis of a control signal and is accommodated in the camera case, wherein the controller receives a control signal output to the primary coil unit through the secondary coil unit.

9. The cameral device according to claim 5, wherein optical communications are carried out between the video signal transmitter and the video signal receiver.
